(19) United States
(12) Patent Application Publication
(10) Pub. No.: US 2009/0130290 A1
(43) Pub. Date: May 21, 2009

(54) Flavored Licorice Root Segments

(76) Inventor: Darryl Keith McCray, Jersey City, NJ (US)

Correspondence Address: Ashok Tankha, 36 Greenleigh Drive, Sewell, NJ, 08080, US

(21) Appl. No.: 12/271,928

(22) Filed: Nov. 17, 2008

Related U.S. Application Data
(60) Provisional application No. 60/989,380, filed on Nov. 20, 2007.

(51) Int. Cl. A23L 1/222; A23L 1/48; A23L 1/22

(52) U.S. Cl. 426/615; 426/650; 426/651

(57) ABSTRACT

Disclosed herein is a method of preparing flavored licorice root segments for consumption. Licorice roots are segmented to a predefined length to obtain licorice root segments. A flavoring mixture for flavoring the licorice root segments is prepared by mixing a flavoring substance and a carrier substance. The flavoring mixture may comprise about 1 part to about 40 parts by weight of the flavoring substance and about 100 parts by weight of the carrier substance. The flavoring substance contains flavoring elements. The carrier substance receives the flavoring elements from the flavoring substance in the prepared flavoring mixture. Flavor is imparted to the licorice root segments by immersing the licorice root segments in the prepared flavoring mixture. The received flavoring elements are transferred from the carrier substance to the licorice root segments. The transferred flavoring elements are absorbed by the immersed licorice root segments to yield flavored licorice root segments for consumption.

### CROSS REFERENCE TO RELATED APPLICATIONS

This application claims the benefit of provisional patent application number U.S. 60/989,380 titled “Method of Creating Organically Flavored Licorice Root”, filed on Nov. 20, 2007 in the United States Patent and Trademark Office.

### BACKGROUND

This invention, in general, relates to a method of flavoring roots. More particularly, this invention relates to flavoring licorice root segments for consumption.

Licorice roots are typically used to extract a sweet flavor. Licorice roots may be obtained from a licorice (Glycyrrhizin glabra) plant. The licorice plant grows in the wild in many Middle Eastern, European and west Asian countries. Licorice roots are used worldwide in medicines and for flavoring. Licorice roots function as an effective expectorant. Licorice roots have adaptogens which help in regulating the functioning of hypothalamic glands, pituitary glands, and adrenal glands. Licorice roots may also be used for treatment of auto-immune conditions including lupus, scleroderma, rheumatoid arthritis, and animal dander allergies. Furthermore, licorice roots also aid in preventing hyperkalemia. Different properties of licorice roots have led to use of licorice roots in medicines, cough syrups, herbal supplements, gum, tobacco, drinks and candy.

The sweet flavor extracted from the licorice roots is referred to as licorice extract. Candies, drinks, gum and medicines are often artificially flavored using the licorice extract. Some beneficial properties of the licorice roots in its raw form may be lost during licorice extraction. Hence, the artificial flavors made using the licorice extract may be devoid of beneficial properties. The licorice extract also lacks the fibrous quality of the licorice roots.

Licorice roots are fibrous and retain the beneficial properties contained in the raw form of licorice roots. Licorice roots may be chewed to maintain oral health. Licorice roots may also help a user overcome a smoking addiction. Moreover, flavoring licorice roots enhances taste of the licorice roots. Hence there is a need for preparing flavored licorice root segments for consumption.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method disclosed herein addresses the above stated need for preparing flavored licorice root segments for consumption. Licorice roots are obtained from a licorice plant. The licorice roots are segmented to a predefined length to obtain licorice root segments. The licorice roots may be dried prior to the segmentation of the licorice roots. A flavoring mixture for flavoring the licorice root segments is prepared by mixing a flavoring substance and a carrier substance. The flavoring substance contains one or more flavoring elements. The flavoring mixture may, for example, comprise about 1 part to about 40 parts by weight of the flavoring substance and about 100 parts by weight of the carrier substance. The carrier substance may, for example, be a carrier oil. The carrier oil may, for example, be an enriched expeller pressed safflower oil. The flavoring mixture may, for example, further comprise an essential oil. The essential oil may, for example, be an organic spearmint flavor oil for chocolate.

The flavoring substance and the carrier substance may be mixed in a mixing device. The carrier substance receives the flavoring elements from the flavoring substance in the prepared flavoring mixture. Flavor is imparted to the licorice root segments by immersing the licorice root segments in the prepared flavoring mixture. The licorice root segments are immersed in the prepared flavoring mixture in a mixing receptacle. The carrier substance transfers the received flavoring elements to the licorice root segments. The immersed licorice root segments absorb the transferred flavoring elements to yield flavored licorice root segments for consumption. The flavored licorice root segments may be dried prior to consumption.

The flavored licorice segments are fibrous and retain beneficial properties contained in the raw form of licorice roots. The flavored licorice root segments may be chewed to maintain oral health. The flavored licorice root segments may also help a user overcome a smoking addiction.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein

FIG. 1 illustrates a method of preparing flavored licorice root segments for consumption.

### DETAILED DESCRIPTION OF THE INVENTION

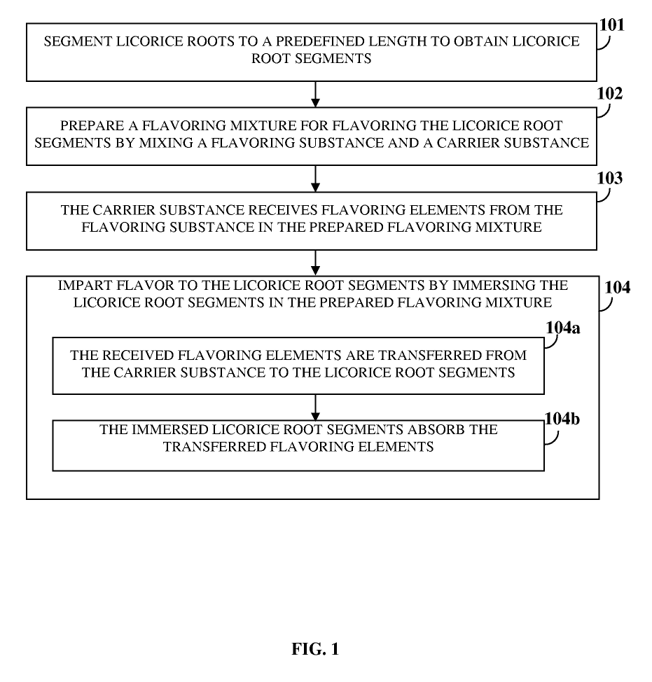

FIG. 1 illustrates a method of preparing flavored licorice root segments for consumption. The licorice roots may be obtained from a licorice (Glycyrrhizin glabra) plant. The licorice plant may be cultivated and harvested. The cultivated licorice plant may be a certified licorice plant. The licorice roots may be separated from the licorice plant following the harvest. The licorice roots may be used within thirty days of harvesting. The licorice roots are cleaned after separating them from the licorice plant. The licorice roots may be cleaned by rinsing with purified water. The licorice roots are segmented to a predefined length after cleaning. The licorice roots are segmented 101 to a predefined length to obtain multiple licorice root segments. The licorice roots may be dried prior to the segmentation of the licorice roots. The predefined length may depend on the diameter of the licorice roots. The predefined length may, for example, be 6 inches for licorice roots of diameter 0.75 inches, 3 inches for licorice roots of diameter 0.375 inches, 12 inches for licorice roots of diameter 1.5 inches, etc. The licorice root segments may be stored at a temperature below 115 degrees Fahrenheit.

A flavoring mixture for flavoring the licorice root segments is prepared 102 by mixing a flavoring substance and a carrier substance. The flavoring substance contains one or more flavoring elements. The flavoring mixture may, for example, comprise about 1 part to about 40 parts by weight of the flavoring substance and about 100 parts by weight of the carrier substance. The flavoring substance and the carrier substance may be mixed in a mixing device. The mixing device may be sealed to prevent the prepared flavoring mixture from spilling. The mixing device may, for example, be a plastic container. The carrier substance and the flavoring substance may be mixed by manually shaking the mixing device or by mechanically stirring the carrier substance and the flavoring substance in the mixing device.

The carrier substance may be an oil based carrier substance or a non-oil based carrier substance. The oil based carrier substance used may be a carrier oil, for example, safflower oil, grape seed oil, etc. The safflower oil may be obtained by pressing safflower seeds in an expeller. An expeller is screw type machine used for extracting oil from seeds. The safflower oil comprises tocopherol. Tocopherol is an organic compound comprising vitamin E. In addition to the carrier oil, the flavoring mixture may, for example, further comprise about 100 parts by weight of an essential oil. The non-oil based carrier substance used may, for example, be water. The carrier substance receives 103 the flavoring elements from the flavoring substance in the prepared flavoring mixture. The flavoring substance may be a fluid flavoring substance or a non-fluid flavoring substance. The flavoring substance may also be an organic flavoring substance. The organic flavoring substance may, for example, be an organic apple essential oil. The non-fluid flavoring substance may, for example, be a dissolvable flavoring powder.

A synthetic aroma compound may also be used as the flavoring substance. The flavoring substance imparts a flavor selected from different groups. A first group may, for example, comprise mango, ginger, cantaloupe, butter pecan, grape fruit, pineapple, plum, orange, lemon, and cinnamon. A second group may, for example, comprise spearmint, peppermint, coffee, pina colada, chocolate, sangria, banana, black raspberry, and blueberry. A third group may, for example, comprise apple, kiwi, pear, cranberry, pomegranate, peach, passion fruit, papaya and watermelon. The different groups may further represent the flavoring substance that may be added to the carrier substance in predefined amounts. In a first example, 5 ml of the flavoring substance belonging to the first group may be mixed with 35 ml of the carrier substance. In a second example, 4 ml of the flavoring substance belonging to the second group may be mixed with 20 ml of the carrier substance. In a third example, 1 ml of the flavoring substance belonging to the third group may be mixed with 20 ml of the carrier substance.

The flavor is imparted 104 to the licorice root segments by immersing the licorice root segments in the prepared flavoring mixture. The licorice root segments may be immersed in a mixing receptacle containing the prepared flavoring mixture. The mixing receptacle may, for example, be a polymeric tub capable of retaining 166 ounces of the prepared flavoring mixture. Predetermined quantities of the licorice root segments and predetermined quantities of the prepared flavoring mixture are placed in the mixing receptacle in appropriate ratios for imparting the flavor to the licorice root segments. The appropriate ratios may, for example, be one pound of licorice root segments in three quarter ounces of the prepared flavoring mixture. One pound of licorice root segments may, for example, be about 80 sticks, 120 sticks, etc. The prepared flavoring mixture and the licorice root segments are mixed in the mixing receptacle such that the licorice root segments do not break.

The carrier substance transfers 104a the received flavoring elements to the licorice root segments. The transferred flavoring elements are absorbed 104b by the immersed licorice root segments. The licorice root segments may be immersed in the prepared flavoring mixture for five minutes to allow the licorice root segments to absorb the transferred flavoring elements. After the absorption, the flavored licorice root segments are yielded for consumption. The flavored licorice root segments may be dried prior to the consumption. The flavored licorice root segments may be air dried or may be dried using a drying device. The flavored licorice root segments may be consumed after drying. The flavored licorice root segments may also be consumed before drying.

### EXAMPLE 1

To impart a peppermint flavor to the licorice root segments, a peppermint mixture is prepared by mixing, for example, about 1 part by weight of a peppermint flavoring substance and about 100 parts by weight of a carrier oil using a mixing device. The peppermint flavoring substance contains one or more peppermint flavoring elements. The carrier oil in the peppermint mixture receives the peppermint flavoring elements. The prepared peppermint mixture is then poured into a mixing receptacle. The licorice root segments are immersed in the prepared peppermint mixture in the mixing receptacle. The carrier oil transfers the received peppermint flavoring elements to the immersed licorice root segments to impart the peppermint flavor to the licorice root segments. The immersed licorice root segments absorb the transferred peppermint flavoring elements to yield peppermint flavored licorice root segments for consumption.

### EXAMPLE 2

To impart an orange flavor to the licorice root segments, an orange mixture is prepared by mixing, for example, about 40 parts by weight of an orange flavoring substance and about 100 parts by weight of a carrier oil using a mixing device. The orange flavoring substance contains one or more orange flavoring elements. The carrier oil in the orange mixture receives the orange flavoring elements. The prepared orange mixture is then poured into a mixing receptacle. The licorice root segments are immersed in the prepared orange mixture in the mixing receptacle. The carrier oil transfers the received orange flavoring elements to the immersed licorice root segments to impart the orange flavor to the licorice root segments. The immersed licorice root segments absorb the transferred orange flavoring elements to yield orange flavored licorice root segments for consumption.

### EXAMPLE 3

To impart a cinnamon flavor to the licorice root segments, a cinnamon mixture is prepared by mixing, for example, about 15 parts by weight of a cinnamon flavoring substance and about 100 parts by weight of a carrier oil using a mixing device. The cinnamon flavoring substance contains one or more cinnamon flavoring elements. The carrier oil in the cinnamon mixture receives the cinnamon flavoring elements. The prepared cinnamon mixture is then poured into a mixing receptacle. The licorice root segments are immersed in the prepared cinnamon mixture in the mixing receptacle. The carrier oil transfers the received cinnamon flavoring elements to the immersed licorice root segments to impart the cinnamon flavor to the licorice root segments. The immersed licorice root segments absorb the transferred cinnamon flavoring elements to yield cinnamon flavored licorice root segments for consumption.

### EXAMPLE 4

To impart a spearmint flavor to the licorice root segments, a spearmint mixture is prepared by mixing, for example, about 30 parts by weight of a spearmint flavoring substance, about 100 parts by weight of a carrier oil, and a predetermined quantity of an essential oil, for example, an organic spearmint flavor oil, using a mixing device. The spearmint flavoring substance contains one or more spearmint flavoring elements. The carrier oil in the spearmint mixture receives the spearmint flavoring elements. The prepared spearmint mixture is then poured into a mixing receptacle. The licorice root segments are immersed in the prepared spearmint mixture in the mixing receptacle. The carrier oil transfers the received spearmint flavoring elements to the immersed licorice root segments to impart the spearmint flavor to the licorice root segments. The immersed licorice root segments absorb the transferred spearmint flavoring elements to yield spearmint flavored licorice root segments for consumption.

### EXAMPLE 5

To impart a blueberry flavor to the licorice root segments, a blueberry mixture is prepared by mixing, for example, about 10 parts by weight of a blueberry flavoring substance and about 100 parts by weight of a carrier oil, for example, an enriched expeller pressed safflower oil, using a mixing device. The blueberry flavoring substance contains one or more blueberry flavoring elements. The carrier oil in the blueberry mixture receives the blueberry flavoring elements. The prepared blueberry mixture is then poured into a mixing receptacle. The licorice root segments are immersed in the prepared blueberry mixture in the mixing receptacle. The carrier oil transfers the received blueberry flavoring elements to the immersed licorice root segments to impart the blueberry flavor to the licorice root segments. The immersed licorice root segments absorb the transferred blueberry flavoring elements to yield blueberry flavored licorice root segments for consumption.

### EXAMPLE 6

In another method to impart a peppermint flavor to the licorice root segments, a peppermint mixture is prepared by mixing, for example, about 1 part by weight of a peppermint flavoring substance, about 100 parts by weight of a carrier oil, for example, an enriched expeller pressed safflower oil, and a predetermined quantity of an essential oil, for example, an organic peppermint flavor oil, using a mixing device. The peppermint flavoring substance contains one or more peppermint flavoring elements. The carrier oil in the peppermint mixture receives the peppermint flavoring elements. The prepared peppermint mixture is then poured into a 1 liter mixing receptacle and agitated for about three to four minutes. The licorice root segments may be laid in a single flat layer in another container. The prepared peppermint mixture is poured over the flat layer of licorice root segments. The licorice root segments are left to saturate. The container may be agitated to speed up the saturation process. The saturated licorice roots are then left to absorb the peppermint flavoring elements for about thirty minutes to yield peppermint flavored licorice root segments for consumption.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of preparing flavored licorice root segments for consumption, comprising the steps of:
segmenting a plurality of licorice roots to a predefined length to obtain a plurality of licorice root segments;
preparing a flavoring mixture for flavoring said licorice root segments by mixing a flavoring substance and a carrier substance, wherein said flavoring substance contains one or more flavoring elements, and wherein said carrier substance receives said flavoring elements from the flavoring substance in said prepared flavoring mixture;
imparting flavor to the licorice root segments by immersing the licorice root segments in the prepared flavoring mixture, wherein said step of imparting said flavor comprises the steps of:
transferring said received flavoring elements from the carrier substance to the licorice root segments; and
absorbing said transferred flavoring elements by said immersed licorice root segments;
whereby said flavored licorice root segments are prepared for said consumption.

2. The method of claim 1, further comprising the step of drying said licorice roots prior to said segmentation of the licorice roots.

3. The method of claim 1, wherein said flavoring mixture further comprises an essential oil.

4. The method of claim 1, wherein the licorice root segments are immersed in the prepared flavoring mixture in a mixing receptacle.

5. The method of claim 1, further comprising the step of drying the flavored licorice root segments prior to the consumption.

6. The method of claim 1, wherein said imparted flavor is selected from a group comprising mango, ginger, cantaloupe, butter pecan, grapefruit, pineapple, plum, orange, lemon, and cinnamon.

7. The method of claim 1, wherein said imparted flavor is selected from a group comprising spearmint, peppermint, coffee, pina colada, chocolate, sangria, banana, black raspberry, and blueberry.

8. The method of claim 1, wherein said imparted flavor is selected from a group comprising apple, kiwi, pear, cranberry, pomegranate, peach, passion fruit, papaya, and watermelon.

9. The method of claim 1, wherein said flavoring mixture is a peppermint mixture, wherein said peppermint mixture comprises about 1 part by weight of a peppermint flavoring substance and about 100 parts by weight of a carrier oil, wherein the licorice root segments are imparted with a peppermint flavor on immersion in the peppermint mixture.

10. The method of claim 1, wherein said flavoring mixture is an orange mixture, wherein said orange mixture comprises about 40 parts by weight of a orange flavoring substance and about 100 parts by weight of a carrier oil, wherein the licorice root segments are imparted with an orange flavor on immersion in the orange mixture.

11. The method of claim 1, wherein said flavoring mixture is a cinnamon mixture, wherein said cinnamon mixture comprises about 15 parts by weight of a cinnamon flavoring substance and about 100 parts by weight of a carrier oil, wherein the licorice root segments are imparted with a cinnamon flavor on immersion in the cinnamon mixture.

12. The method of claim 1, wherein said flavoring mixture is a spearmint mixture, wherein said spearmint mixture comprises about 30 parts by weight of a spearmint flavoring substance and about 100 parts by weight of a carrier oil, wherein the licorice root segments are imparted with a spearmint flavor on immersion in the spearmint mixture.

13. The method of claim 1, wherein said flavoring mixture is a blueberry mixture, wherein said blueberry mixture comprises about 10 parts by weight of a blueberry flavoring substance and about 100 parts by weight of a carrier oil, wherein the licorice root segments are imparted with a blueberry flavor on immersion in the blueberry mixture.

14. A chemical composition for flavoring licorice root segments, comprising:
about 1 part to about 40 parts by weight of a flavoring substance; and
about 100 parts by weight of a carrier substance.

15. The chemical composition of claim 14, wherein said carrier substance is a carrier oil.

16. The chemical composition of claim 14, further comprising about 100 parts by weight of an essential oil.

17. The chemical composition of claim 14, wherein said flavoring substance is one of a fluid flavoring substance and a non-fluid flavoring substance.

18. The chemical composition of claim 14, wherein said flavoring substance imparts a flavor selected from a group comprising mango, ginger, cantaloupe, butter pecan, grapefruit, pineapple, plum, orange, lemon, and cinnamon.

19. The chemical composition of claim 14, wherein said flavoring substance imparts a flavor selected from a group comprising spearmint, peppermint, coffee, pina colada, chocolate, sangria, banana, black raspberry, and blueberry.

20. The chemical composition of claim 14, wherein said flavoring substance imparts a flavor selected from a group comprising apple, kiwi, pear, cranberry, pomegranate, peach, passion fruit, papaya, and watermelon.
